(19) United States
(12) Patent Application Publication
(10) Pub. No.: US 2008/0086658 A1
(43) Pub. Date: Apr. 10, 2008

(54) BACKUP CONTROL DEVICE AND SYSTEM FOR DATA PROCESSING SYSTEM

(75) Inventor: Kouitirou TAKAHASI, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/828,772

(22) Filed: Jul. 26, 2007

(30) Foreign Application Priority Data
Oct. 5, 2006 (JP) 2006-274084

(51) Int. Cl. G06F 11/16

(52) U.S. Cl. 714/6; 714/E11.121

(57) ABSTRACT

The backup system discussed herein uses a control device optimally for a backup process, and to process backup requests within a short period of time. Moreover, the system also provides a control device which operates stably even when a congested state occurs in the communication link connecting a plurality of devices and the control device and thereby a fault occurs in the communication link.

The control device includes a queuing unit to process data backup process requests received from a plurality of devices and administrating an execution sequence, and an execution control processing unit executing a plurality of backup processes administrated in the queuing unit within a range of a predetermined value. Jobs are executed on the queue when the number of jobs simultaneously executing is less than the predetermined value.

### CROSS-REFERENCE TO RELATED APPLICATIONS

This application is related to and claims the benefit of Japanese Patent Application No. 2006-274084, filed Oct. 5, 2006, in the Japanese Intellectual Property Office, the disclosure of which is incorporated herein by reference.

### BACKGROUND

1. Field of the Invention

The embodiments discussed herein relate to a control device connected to a single device or a plurality of devices via a communication line to control execution of jobs; and more specifically, to a control device for receiving and storing backup data transmitted from a plurality of devices, and for transmitting the backup data to each device on the basis of requests from a plurality of devices, and to a backup system comprising a plurality of devices and a control device.

Moreover, the embodiments also relate to a backup control device and a backup control system for controlling backup processes by combining a total backup for all data and a differential backup for only updated data.

2. Description of the Related Art

In view of avoiding device data loss due to a fault occurrence in the same device, a backup system has been employed to store important data, which is to be stored in the device, in a control device. The backup system periodically transmits the backup data to the control device in order to immediately recover the present situation even if the device generates a fault occurrence, and recovers the data by receiving the backup data from the control device if the data is lost.

Generally, a backup system is constituted to connect a plurality of devices to a control device, register jobs transmitted from such devices to a job queue provided for each job class in accordance with the class to which the job belongs (job class) and priority in the job class of the same job, select the jobs in accordance with a priority from a high order job class, and drive the selected jobs sequentially with the control device.

Moreover, a job queue is provided to manage, the execution sequence of jobs to be executed, and areas where the jobs exist which are required for execution of such jobs. Furthermore, management information is stored in a non-volatile storage medium and is administrated with a job scheduler, considering generation of a system-down or fault.

Here, a job is the unit of a set of jobs executed by a computer defined with a user, and is administrated using the job queue with the job scheduler as explained above.

In recent years, the number of direct access devices installed, such as magnetic disk drives, has increased, thereby resulting in increased backup times because the quantity of data has increased rapidly in a system in which a plurality of devices and a control device are connected via communication links.

Conventionally, the backup process is implemented within a predetermined period of a limited time frame, such as midnight and holidays, in which heavy-load transaction processes are not executed. However, in an environment where the control device for storing the backup data is used in common, the processing time becomes longer because only one control device processes the data of a plurality of devices. Therefore, in a system with a large quantity of processes, the backup time increases to such a degree resulting in problems with the next days online jobs because of the increase in the quantity of data.

In a conventional backup system, all of the data on the devices as the object of the backup process is copied on a magnetic tape using another storage device, such as a magnetic tape library device, each time the backup process is executed.

However, because the conventional backup process requires all the data of the devices to be copied as the backup object, the backup time also increases due to an increase in the quantity of data.

As a backup method for shortening backup time, a differential backup method has been proposed, in which the data not updated is not considered as the backup object, but instead, only the updated data is subjected to the backup process.

The differential backup method combines backup of all data (hereinafter referred to as “total backup”) and backup of only the data updated after the total backup (hereinafter referred to as “differential backup”). Moreover, the differential backup is classified into an accumulation type backup, a non-accumulation type backup, and a combination type backup of the aforementioned two types. The backup method to be employed is selected in accordance with which backup should be considered as the reference (standard) for determination of an update area. Namely, the accumulation type backup determines the update data with reference to the preceding total backup, while the non-accumulation type backup determines the update data with reference to the preceding total backup or the preceding differential backup.

Regarding a backup technology for a system realizing data backup via a network, the Japanese Unexamined Published Patent Application No. 2004-252829 discloses a technology, in which a plurality of inputted backup requests are executed by obtaining a combination of the executable backup requests and an execution sequence on the basis of a relationship between the number of backup devices used and the time required for the backup.

However, the backup method using the differential backup process of the related art also has a problem, in a case where a plurality of backup requests are processed simultaneously. More specifically, when the priority of a backup process becomes higher, and the quantity of processes increases remarkably, congestion of communication links is generated and a heavier load is applied to the control device. Accordingly, a delay time for realizing the normal backup process becomes longer. Therefore, a backup time has been specified for each day for each of a plurality of devices.

However, if the differential backup start time of each device is specified with a sufficient allowance, a problem rises here, in which a longer idle time is generated when no backup process is executed.

Moreover, in the backup technology of the related art, a system manager is required to adequately determine the schedule from the frequency of the backup and the time required for backup of respective data. Accordingly, it is difficult to employ such a method in a large-scale system because very complicated scheduling is necessary.

### SUMMARY

Considering the background discussed above, it is an object of the embodiments to realize optimum usage of a backup control device and to process a backup request within a shortest period.

Moreover, according to another object of the embodiments, there is provided a control device which can operate stably, even when the communication links connecting a plurality of devices and the control device enter a congested state, and a fault occurs in the devices and the links.

A first aspect in accordance with the embodiments comprises a queuing unit processing data backup process requests received from a plurality of devices and administrating an execution sequence, and an execution control processing unit executing a plurality of data backup processes administrated by the queuing unit within the range of a preset value.

A second aspect in accordance with the embodiments transmits the data backup process requests to the control device and the control device comprises a queuing unit processing data backup process requests received from a plurality of devices and administrating the execution sequence, and an execution control processing unit executing a plurality of data backup processes administrated by the queuing unit within the range of a preset value.

A third aspect in accordance with the embodiments controls a computer to execute a procedure to process data backup process requests received from a plurality of devices and administrating the execution sequence, and a procedure to execute a plurality of the administrated data backup processes within the range of a preset value.

According to the backup control device and system of the embodiments, because the administrated jobs are executed within a preset range to control the job processes by providing a queuing unit for administrating jobs and execution sequence thereof, the most efficient backup work can be implementedby inputting the backup request and the maximum simultaneous execution number to execute the jobs equal to or less than a constant number to such a backup request.

Accordingly, by employing the queuing unit the idle time can be shortened when no backup is executed in comparison with the related art, because when a job is executed, the next job queued in the queuing unit is executed, and it is therefore possible to provide a backup control device and system which can be operated effectively.

Moreover, the backup control device and system of the present invention may be operated stably by providing the maximum number of simultaneous execution processes to prevent occurrence of congestion in the network, allowing simultaneous operations of backup processes by many computers.

Additional aspects and/or advantages of the invention will be set forth in part in the description which follows and, in part, will be obvious from the description, or may be learned by practice of the invention.

### BRIEF DESCRIPTION OF THE DRAWINGS

FIG. 1 illustrates a schematic structure of an online network of a backup system.

FIG. 2 illustrates a schematic system structure of an online network of a backup system.

FIG. 3 is a flowchart of processes executed by a job acceptance processing section.

FIG. 4 is a flowchart of processes executed by a job execution control processing section.

FIG. 5 is a flowchart of processes executed by a job completion notification processing section.

FIG. 6 illustrates a job information table diagram registered to a job queue.

### DETAILED DESCRIPTION OF THE EMBODIMENTS

Reference will now be made in detail to the various embodiments of the embodiments, examples of which are illustrated in the accompanying drawings, wherein like reference numerals refer to like elements throughout.

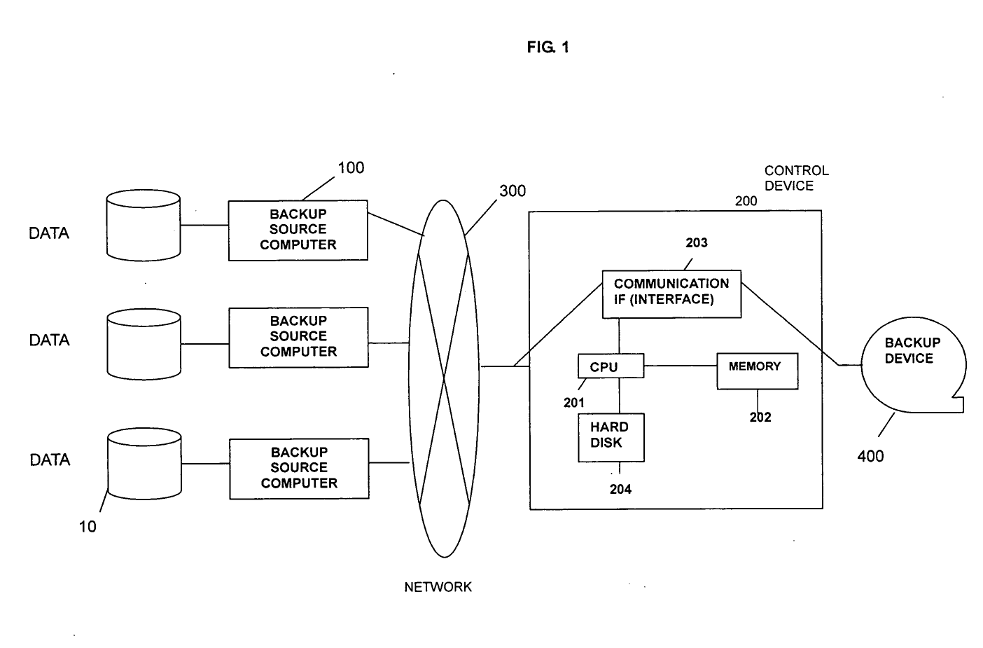

FIG. 1 illustrates an example of a schematic structure of a backup system as an embodiment. The backup system comprises a backup source computer 100, a data 10 stored in the backup source computer 100, a control device 200 transmitting and receiving data 10 to and from the backup source computer 100 via a network 300, and a backup device 400 storing the data 10.

The control device 200 comprises a CPU 201, a memory 202 connected to the CPU 201, a communication IF (Interface) 203 connected to the CPU 201, and a hard disk 204 connected to the CPU 201.

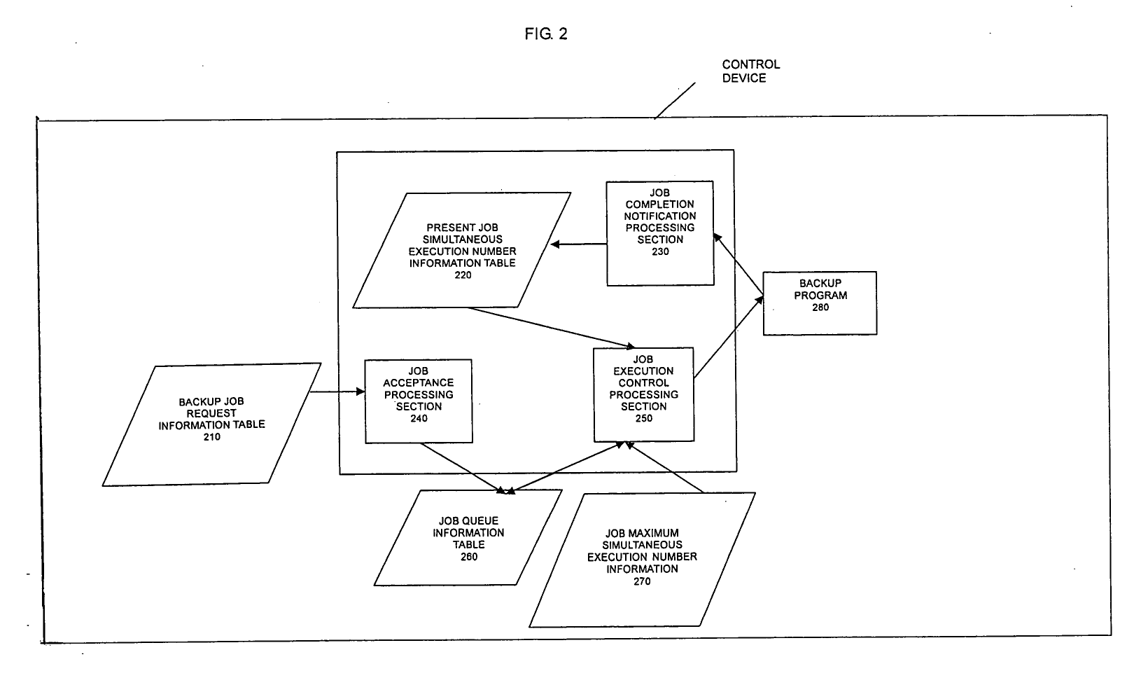

Moreover, the hard disk 204 (See FIG. 2) stores a backup job request information table 210, a present job simultaneous execution number information table 220, a job completion notifying program 230, a job accepting program 240, a job execution control program 250, a job queue information table 260, a job maximum simultaneous execution number information table 270, a backup program 280, and information tables storing information including an identification number of the backup object data, an identifier indicating a backup profile and an identification number of the backup device 400 as the information of the backup device 400 of the backup destination address which will be explained later.

Regarding the identifier indicating the backup profile, an identifier indicating the total backup, non-accumulation type differential backup or accumulation type backup is used. The backup program 280 will be operated with reference to the information tables. Moreover, the backup program 280 utilizes a job completion notification program for notifying completion of job.

The CPU 201 processes information when the program used to process the data provided in the memory 202 is executed. The memory 202 is used for temporarily storing the data at the time of processing the data.

Moreover, the hard disk 204 stores the application method of the control device 200 and the information used to solve a failure of the control device 200. The communication IF 203 executes data communication among the CPU 201 in the control device 200, backup source computer 100 and backup device 400 via the network 300.

With the structure described previously, the CPU 201 of the control device 200 transmits the data 10 stored in the backup source computer 100 to the backup device 400 via the network 300. The CPU 201 receives the backup information from the backup source computer 100 through the communication IF 203. This received information is the data inputted from a keyboard or a mouse connected to the backup source computer 100.

The backup source computer 100 can be connected to the network 300 to facilitate communication with the control device 200 through the network 300.

In this embodiment, a control device 200 and a backup device 400 are provided, however, this embodiment can also be provided with a plurality of control devices and backup devices. In addition, it is also possible that any one of the plurality of control devices is capable of sending a backup request to any one of the backup devices. Moreover, the backup device 400 administrates the backup processes to determine the backup schedule for the system as a whole.

Regarding the backup device 400, a similar magnetic tape library device used in the related art is also used in this embodiment; however, another storage device such as an optical disk storage device, an optical magnetic disk storage device or a combination of the aforementioned storage devices may be used in the present invention. Moreover, a storage medium is not limited to a magnetic tape device. However, it is preferable to use a large capacity storage device as a storage destination of backup data.

In the present invention, a DBMS (Data Base Management System) is used as a software to administrate a database as common data, and to respond to an access request for data 10 in order to administrate the backup object data; however, other application software may also be used. In addition, in this embodiment, the backup object data is defined as the data stored in the database, but the present invention is never limited thereto, and the data stored in files may also be used.

In addition to the embodiment described above, a method has also been proposed, in which a backup process is executed by providing a WAN (Wide Area Network) between the LAN's (Local Area Network). For example, the method is often employed with important data such as bank data which is remotely backed up to realize recovery even if an accident or disaster occurs. In such a case, a narrow band WAN is used, and is required to transmit the data in a quantity as small as possible (or transmitting time is shortened).

FIG. 2 is a diagram illustrating an example of a schematic system structure of the online network of the backup system.

The control device 200 realizes a data transfer method of the present invention by comprising a job accepting program 240 accepting the backup object data stored in the backup job request information table 210, and executing a backup process to store the backup object data in the job queue information table 260. Furthermore, a job execution control program 250 simultaneously verifies the stored backup object data in the job queue information table 260 with the job accepting program 240. Also, the job maximum simultaneous execution number information table 270 stores a maximum execution number to execute simultaneously the stored backup object data, and the present backup data execution number stored in the present job simultaneous execution information table 220 relates to executing the data backup process. Furthermore, a job completion notifying program 230 notifies completion of the data backup process when the job execution control program 250 has detected completion of the backup process on the basis of the backup program.

In FIG. 2, the job accepting program 240 is stored in the hard disk 204 of the control device, read as required into the memory 202, executed by the CPU 201 and writes the backup data to the job queue information table 260 from the backup job request information table 210.

In FIG. 2, the job execution control program 250 is stored in the hard disk 204 of the control device 200, read as required into the memory 202, and executed by the CPU 201 to verify the job queue information table 260, job maximum simultaneous execution number information table 270 and the job present simultaneously execution number information table 220, and reads the result into the backup program 280.

In FIG. 2, the job completion notifying program 230 is stored in the hard disk 204 of the control device 200, read as required into the memory 202, executed by the CPU 201 and writes the completion notification of the backup process to the present job simultaneous execution number information table 220 when the data backup process by the job execution control program 250 is completed.

In FIG. 2, the job execution control program 250 functions to complete the backup process of the control device of this embodiment, upon reading the notification completion of the backup process in the present job simultaneous execution number information table 220.

The backup process in this embodiment may be the total backup process copying the total data as the backup object medium to a backup device 400 or may be the differential backup process extracting, as the differential data, the data updated for the reference backup process data among the total data as the backup object medium and copying such differential data into the backup device 400.

In the backup system of this embodiment, the backup operation environment is defined by the job execution control program 250 on the basis of the backup defining information for previously defining the backup management. The job execution control program 250 registers, for management, the defined backup operation environment, information of the backup object data, and information regarding the backup destination address of the backup device 400 to the table 204 of the control device 200 shown in FIG. 1.

Next, the backup operation in the backup system of FIG. 2 in the embodiment of the present invention will be explained below.

When the backup job request information table 210 externally instructs the start of the backup execution process for the job execution control program 250 provided in the control device 200, the job accepting program 240 of the control device 200 accepts the instructed backup job request.

The job queue information table 260 is provided in the hard disk 204 of the control device, and the job queue information table 260 sequentially stores the jobs of the backup data in the sequence of their acceptance.

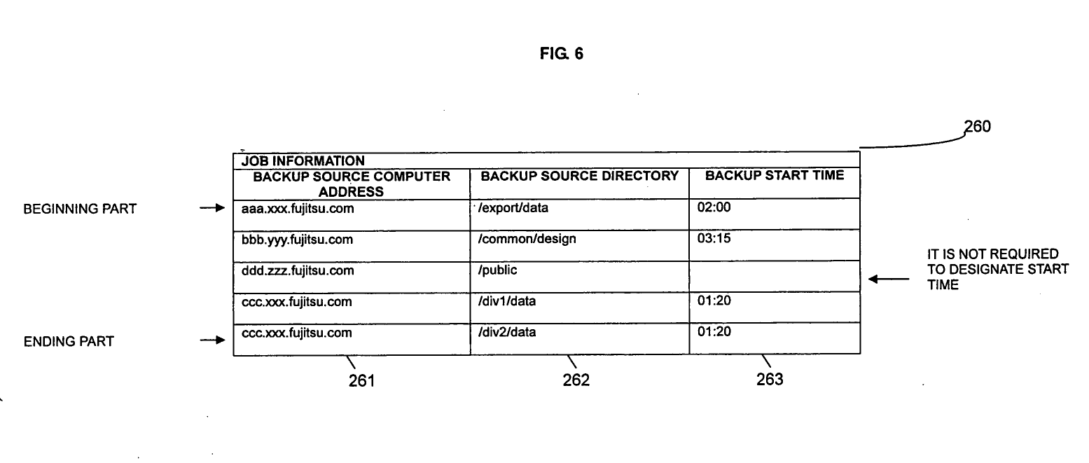

A format of the job queue information table 260 is illustrated in FIG. 6, and is described later.

The job execution control program 250 extracts the data 10 with reference to the accepted backup data arranged in the job queue information table 260, and the job maximum simultaneous execution number stored in the job maximum simultaneous execution number information table 270 in the hard disk 204 of the control device 200. The extracted backup data is stored into the backup device 400 through the communication IF 203.

The job execution control program 250 supervises the present job simultaneous execution number information table 220 in the hard disk 204 of the control device 200, and extracts and executes a job corresponding to the data stored in the job queue information table 260 when the number of jobs corresponding to the backup data executed presently in the present job simultaneously execution number information table 220 is less than the job maximum simultaneous execution number in the job maximum simultaneous execution number information table 270.

The job maximum simultaneous execution number in the job maximum simultaneous execution number information table 270 is determined by traffic transitioning through the network 300 which is connected to the backup source computer 100.

To determine the job maximum simultaneous execution number for a selected day, a graph may be obtained by recording daily data traffic, generating a monthly graph from the recorded daily data traffic, selecting a respective day from Sunday to Saturday to execute the backup process from the generated monthly graph, and obtaining the average of the selected day.

Regarding the selected day graph used here, a graph of the preceding day or an average graph of the preceding week may also be used.

In the selected day graph, changes in the quantity of data 10 in the transmission and reception between the backup source computer 100 and the control device 200 may be indicated by plotting the number of bytes per second on the vertical axis, with time on the horizontal axis.

Prior to starting a backup operation, a check of the traffic transitioning through the network 300 in the backup time frame from the selected day graph is performed.

For example, in a case where the backup time frame is extended up to 04:00 from 22:00 every day, it is assumed that the maximum traffic is about 10 Mbps in this time frame. When the bandwidth of the network 300 is 50 Mbps, a bandwidth of 40 Mbps (obtained by subtracting the maximum traffic of 10 Mbps from the network bandwidth of 50 Mbps) is usually used for the backup process.

In a case where the backup process requires the bandwidth of 10 Mbps for only one job, the job maximum simultaneous execution number obtained is 4, which is calculated by dividing the 40 Mbps generally used for the backup process with the bandwidth of 10 Mbps used for the backup process of only one job. The job maximum simultaneous execution number is transmitted to the job execution control program 250. Accordingly, the job maximum simultaneous execution number is set responsive to a non-backup communication load on the network 300 and the job load.

In this embodiment, the job maximum simultaneous execution number stored in the job maximum simultaneous execution number information table 270 is inputted by a user via the control device 200.

When the jobs, corresponding to the backup data, are all copied to the backup device 400 after extraction from the job queue information table 260 and execution on the basis of the backup program 280, the job execution control program 250 executes the completion notifying process of the job completion notifying program 230.

Here, when the differential data is defined as the backup process object, the job execution control program 250 of the control device 200 executes, for each differential backup process, a non-accumulation type differential backup process and an accumulation type differential backup process. The non-accumulation type differential backup process extracts the differential data updated with reference to the total backup data or differential backup data immediately before the data 10 as the backup object medium and to copy such differential data to the backup device 400. The accumulation type differential backup process extracts the differential data updated with reference to the preceding total backup data of the data 10 as the backup object medium and to copy such differential data to the backup device 400.

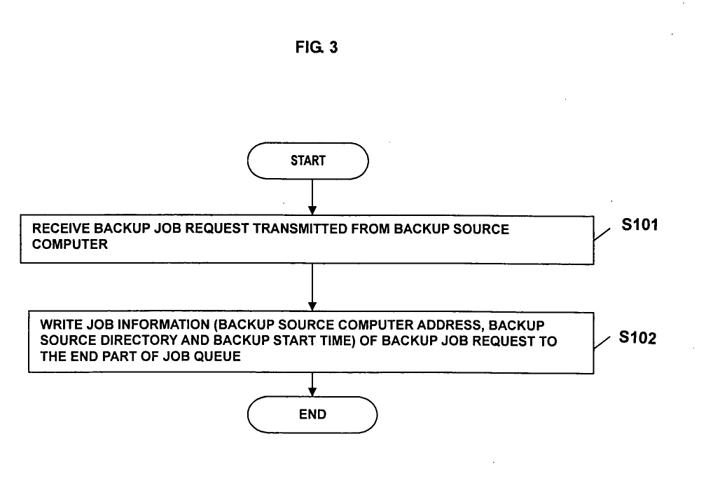

FIG. 3 is a flowchart of processes executed by a job accepting program 240 of FIG. 2.

Regarding the processes of the job accepting program 240, the backup job request transmitted from the backup source computer is received first (step S101).

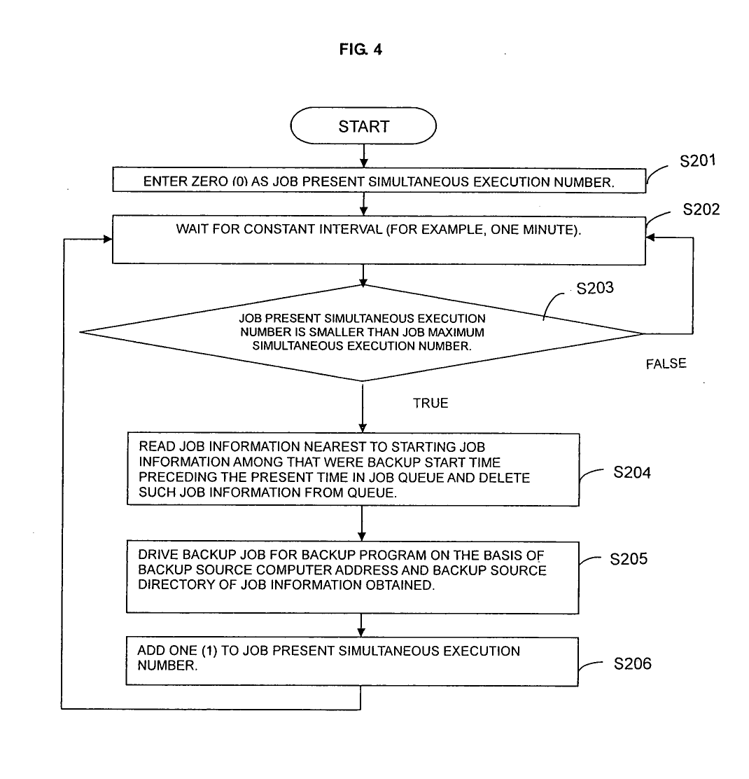

Information related to the job as the data for the requesting backup job (explained later with reference to FIG. 4) is written at the end part of the job queue information table 260 (step S102).

FIG. 4 is a flowchart showing processes to be executed related to the job execution control program 250 of FIG. 2. For the process of this job execution control program 250, zero (0) is inputted first into the present job simultaneous execution number information table 220 (step S201).

After zero (0) is inputted into the present job simultaneous execution number information table 220, a delay of a constant period (for example, about one minute) is required (step S202).

Next, a check regarding whether the job present simultaneous execution number of the present job simultaneous execution number information table 220 is smaller than the job maximum simultaneous execution number of the job maximum simultaneous execution number information table 270 is performed (step S203). If the present job simultaneous execution number is equal to the job maximum simultaneous execution number, the process returns to the step S202.

As described previously, when a plurality of backup processes of many computers are driven simultaneously, a congested state of the network 300 can be prevented by introducing the concept of the maximum simultaneous execution number, to thereby provide a control device which can realize a stable backup process.

Moreover, when the job present simultaneous execution number is smaller than the job maximum simultaneous execution number, the job information nearest the leading information among the job information entries where the backup process start time 263 in FIG. 6, which precedes the present time is read, and then such job information is deleted from the queue in the job queue information table 260 (step S204). That is, if the current time is on or after the start time, the job can be executed.

When the job as the backup data is executed, the next job waiting in the job queue information table is also executed by employing the job queue information table. That is, the next job on the queue can be executed even if the current time has not reached its start time. Accordingly, by providing the job queue information table, the idle time can be shortened when no backup process is executed. Accordingly, a control device which can realize an effective backup process can be provided.

Next, in view of executing the backup process on the basis of the backup source computer address 261 and backup source directory 262 in FIG. 6 of the backup source computer 1007 as the job information obtained, the backup program 280 is driven (step S205).

Here, a value one (1) is added to the present job simultaneous execution number of the present job simultaneous execution number information table 220 (step S206).

After a value one (1) is added to the present job simultaneous execution number of the present job simultaneous execution number information table 220, the process returns to the step S202 to repeat the processes of the steps S202 to 206 until jobs of the backup implementation date are all completed.

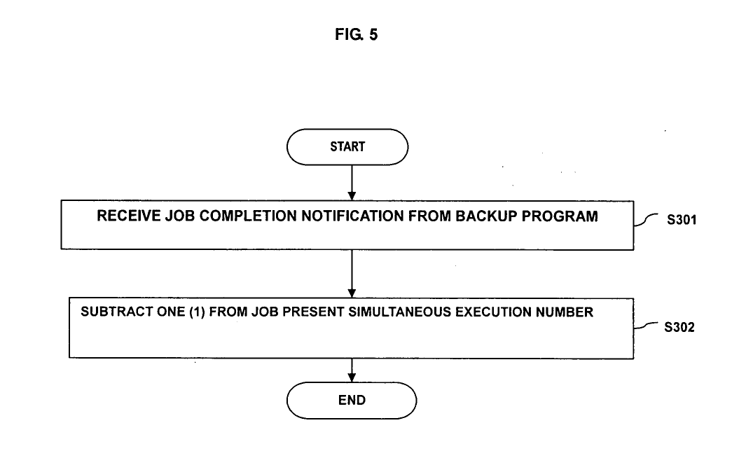

FIG. 5 is a flowchart illustrating the processes executed with the job completion notifying program 230 of FIG. 2.

The job completion notifying program 230 receives the job completion notification from the backup program 280 (step S301).

After a value one (1) is subtracted from the job present simultaneous execution number (step S301), the backup process is completed.

As described previously, the job completion notifying program 230 completes the backup process. Therefore, the job execution control for reading the information is accomplished by setting the present job simultaneous execution number of the present job simultaneous execution number table 220 to zero thereby completing the backup process.

In an embodiment, data backup job requests are queued on a queue, and a backup job for a request on the queue is started when a number of backup jobs being executed is less than a simultaneous job execution number. Furthermore the backup job requests arrive via a network, and the simultaneous job execution number is set responsive to a non-backup communication load on the network and a backup job load.

In the aforementioned embodiment, the non-backup communication load comprises an non-backup communication average network bandwidth during a backup time frame and the backup load comprises a backup process bandwidth. Also, the simultaneous job execution number comprises (network bandwidth−non-backup communication average network bandwidth)/backup process bandwidth. Additionally, the backup jobs have start times and the embodiment further comprises starting a next backup job responsive to the start times.

FIG. 6 illustrates a job information table wherein the jobs of the backup data registered in the job queue information table 260 of FIG. 2 are arranged in the queue.

In this backup job queue information table 260, the address 261 of the backup source computer 100, backup directory 262 of the backup source computer 100 and time 263 to start the backup process are registered.

Regarding the time 263 to start the backup process, it is not required to designate the start time as illustrated in FIG. 6. Moreover, the backup process of the backup source directory 262 arranged in the job queue information table 260 may be sequentially executed from the beginning of the arrangement. Moreover, the backup process may be executed on the basis of the start time by designating the backup start time 263.

1. A controller connected to a plurality of apparatuses through a communication line to process a data backup, comprising:
a queue unit processing requests of said data backup received from said plurality of apparatuses and managing a processing order of said requests; and
an execution control processing unit executing processing of said managed requests in said queue unit within a range of a predetermined value.

2. The controller according to claim 1, further comprising:
a backup job request information unit externally instructs the execution control processing unit to start the data backup process; and
a job accepting processing unit accepting the requests of said data backup received from said plurality of apparatuses when the data backup process is started.

3. The controller according to claim 1, further comprising:
a job maximum simultaneous execution number information unit storing a job maximum simultaneous execution number,
wherein the predetermined value comprises the job maximum simultaneous execution number.

4. The controller according to claim 3, further comprising:
a present job simultaneous execution number information unit storing a present backup data execution number,
wherein the execution control processing unit executes processing of said managed requests when the present backup data execution number is smaller than the job maximum simultaneous execution number.

5. The controller according to claim 3, wherein the job maximum simultaneous execution number is determined by recording the number of requests through the communication line.

6. The controller according to claim 5, wherein the job maximum simultaneous execution number for a selected day is determined by recording the number of requests through the communication line on a daily basis, generating a monthly graph from the recorded daily traffic, and selecting a respective day to execute the processing of said managed requests.

7. The controller according to claim 3, wherein the job maximum simultaneous execution number is calculated by, dividing bandwidth used by the requests of said data backup received from said plurality of apparatuses, by bandwidth used by one of the requests of said data backup received from said plurality of apparatuses.

8. A system, comprising:
a plurality of apparatuses, transmitting requests to process a data backup,
a controller, connected to said plurality of apparatuses through a communication line and receiving said transmitted requests of said data backup,
said controller having;
a queue unit processing requests of said data backup received from said plurality of apparatuses and managing a processing order of said transmitted requests,
an execution control processing unit executing processing of said managed requests in said queue unit within a range of a predetermined value.

9. The system according to claim 8, wherein the plurality of apparatuses comprises backup source computers.

10. The system according to claim 9, wherein the queue unit stores an address corresponding to one of the backup source computers, a backup directory corresponding to one of the backup source computers, and a time to start the data backup process corresponding to one of said backup source computers.

11. The system according to claim 8, further comprising a backup device which stores a result of the execution control processing unit.

12. The system according to claim 11 wherein the backup device comprises a magnetic tape library device, an optical disk storage device, or a combination of the magnetic tape library device and the optical disk storage device.

13. The system according to claim 8, wherein the managed requests are executed sequentially.

14. The system according to claim 8, further comprising:
LANs (Local Area Networks) comprising the plurality of appratuses; and
a WAN comprising the communication line.

15. A method of processing a data backup of a controller connected to a plurality of apparatuses through a telecommunication line, comprising:
processing requests of said data backup received from said plurality of apparatuses and managing a processing order of said requests;
executing processing of said managed requests within a range of a predetermined value.

16. A computer-readable medium storing a control program causing a computer to display status information of a controller connected to plurality of apparatuses through a communication line and processing a data backup, wherein said control program causes said computer to execute:
processing requests of said data backup received from said plurality of apparatuses and managing a processing order of said requests;
executing processing of said managed requests within a range of a predetermined value.

17. A method, comprising:
queuing data backup job requests on a queue; and
starting a backup job for a request on the queue when a number of backup jobs being executed is less than a simultaneous job execution number.

18. A method according to claim 17, wherein the backup job requests arrive via a network and said method further comprising setting the simultaneous job execution number responsive to a non-backup communication load on the network and a backup job load.

19. A method according to claim 18, wherein the non-backup communication load comprises an non-backup communication average network bandwidth during a backup time frame and the backup load comprises a backup process bandwidth.

20. A method as recited in claim 19, wherein the simultaeous job execution number comprises (network bandwidth−non-backup communication average network bandwidth)/backup process bandwidth.

21. A method as recited in claim 20, wherein backup jobs have start times and said method further comprising starting a next backup job responsive to the start times.
